(19) United States
(12) Patent Application Publication
(10) Pub. No.: US 2016/0189519 A1
(43) Pub. Date: Jun. 30, 2016

(54) Earthquake Warning Method and Earthquake Warning Broadcast System Thereof

(71) Applicant: National Applied Research Laboratories, Taipei City (TW)

(72) Inventors: Pei-Yang Lin, Taipei City (TW); Shieh-Kung Huang, Taoyuan City (TW); Hung-Wei Chiang, Tainan City (TW); Kung-Chun Lu, Hsinchu City (TW); Ting-Yu Hsu, New Taipei City (TW)

(21) Appl. No.: 14/737,499

(22) Filed: Jun. 12, 2015

(30) Foreign Application Priority Data
Dec. 24, 2014 (TW) 103145240

(51) Int. Cl. G08B 21/10; G01V 1/00

(52) U.S. Cl. CPC G08B 21/10; G01V 1/008; G01V 2210/1232

(57) ABSTRACT

The present disclosure provides an earthquake warning method. The earthquake warning method includes deploying a set of seismic device in a zone according to a criterion to detect an earthquake, generating a first earthquake warning signal when the earthquake is detected, receiving the first earthquake warning signal and a second earthquake signal; executing an decision determination according to the first earthquake warning signal and the second earthquake signal; sending first earthquake warning signal or a second earthquake signal according to the decision determination and broadcasting an earthquake warning.

### BACKGROUND OF THE INVENTION

1. Field of the Invention

The present invention relates to an earthquake warning method and an earthquake warning broadcast system thereof, and more particularly, to a local earthquake warning method and an earthquake warning broadcast system thereof.

2. Description of the Prior Art

Considering casualties and property loss brought by earthquake, government and related organizations establish seismological monitoring centers to monitor detail information such as times, places, types, etc., of earthquake. However, since precise earthquake detecting instruments are quite expensive and not so popular, earthquake alarm messages, which are results detected by the seismological monitoring center, are broadcasted to people through the media such as television, radio, network, etc. However, the media broadcasting the earthquake alarm message is not timely enough and the information penetration rate thereof is low. People usually receive the earthquake alarm message after the earthquake occurred, such people are too late to take earthquake contingency measures and irreparable casualties and property loss are caused.

Even though there are small earthquake warning broadcast systems in the market, the price thereof is too expensive, in addition, the accuracy of which is intolerable and to be improved, such that false alarm might occur due to human factors. Therefore, it is necessary to improve the prior art.

### SUMMARY OF THE INVENTION

It is therefore a primary objective of the present invention to provide an earthquake warning method and an earthquake warning broadcast system thereof, to reduce the cost of the earthquake warning broadcast system.

The present invention discloses an earthquake warning method. The earthquake warning method comprises deploying a set of earthquake detectors within a zone according to a specific rule to detect an earthquake wave; generating a first earthquake warning signal when the earthquake wave is detected; receiving the first earthquake warning signal and a second earthquake warning signal; performing a decision determination according to the first earthquake warning signal and the second earthquake warning signal; sending the first earthquake warning signal or the second earthquake warning signal to a plurality of warning devices according to the decision determination; and broadcasting an earthquake alarm.

The present invention further discloses an earthquake warning broadcast system. The earthquake warning broadcast system comprises a set of earthquake detectors, deployed within a zone according to a specific rule, for detecting an earthquake wave; a local earthquake detecting system, coupled to the set of earthquake detectors, for generating a first earthquake warning signal when the earthquake wave is detected; a central earthquake detecting system, for generating a second earthquake warning signal when the earthquake wave is detected; a decision unit, coupled to the local earthquake detecting system and the central earthquake detecting system, for performing a decision determination according to the first earthquake warning signal and the second earthquake warning signal, and sending the first earthquake warning signal or the second earthquake warning signal according to the decision determination; and a plurality of warning devices, coupled to the decision unit, for receiving the first earthquake warning signal or the second earthquake warning signal, and broadcasting an earthquake alarm.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an earthquake warning broadcast system according to an embodiment of the invention.

FIG. 2 is a schematic diagram of a process according to an embodiment of the invention.

### DETAILED DESCRIPTION

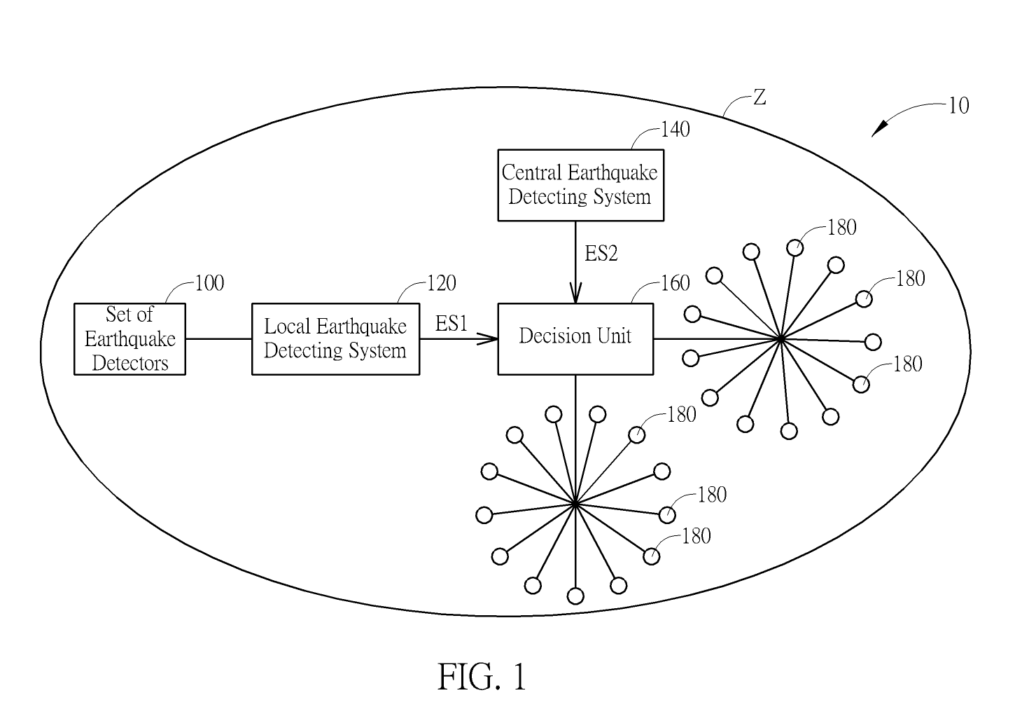

Please refer to FIG. 1, which is a schematic diagram of an earthquake warning broadcast system 10 according to an embodiment of the invention. The earthquake warning broadcast system 10 comprises a set of earthquake detectors 100, a local earthquake detecting system 120, a central earthquake detecting system 140, a decision unit 160 and a plurality of warning devices 180. The set of earthquake detectors 100 comprises at least two earthquake detectors, and are deployed within a zone Z according to a specific rule, for detecting a vertical acceleration of an earthquake wave. The local earthquake detecting system 120 is couple to the set of earthquake detectors 100, for generating an earthquake warning signal ES1. The central earthquake detecting system 140 is utilized for generating a second earthquake warning signal ES2 when the earthquake wave is detected. Preferably, the central earthquake detecting system 140 may be a central seismological monitoring center established by the government and related organizations. The decision unit 160 is coupled to the local earthquake detecting system 120 and the central earthquake detecting system 140, for performing a decision determination according to the earthquake warning signal ES1 and the earthquake warning signal ES2 and sending the earthquake warning signal ES1 or the earthquake warning signal ES2 to the plurality of warning devices 180 according to the decision determination. The plurality of warning devices 180 are coupled to the decision unit 160, for receiving the earthquake warning signal ES1 or the earthquake warning signal ES2, and broadcasting an earthquake alarm according to the earthquake warning signal ES1 or the earthquake warning signal ES2. Preferably, each of the warning devices 180 may be a cheap electronic clock or any other electronic device producing sounds or images, and the earthquake alarm may be in a form of sounds or images instructing subscribers to escape or refuge, such that a damage caused by earthquake is lowered. Since the single local earthquake detecting system 120 is disposed within the zone Z and the earthquake alarm is broadcasted through the plurality of cheap warning devices 180, all of the subscribers within the zone Z may receive the earthquake alarm when an earthquake occurs, such that casualties caused by the earthquake are lowered. Since the cost of deploying the local earthquake detecting system 120 may be shared by the subscribers, in comparison to the earthquake warning broadcast system in the prior art, more people are able to afford the earthquake warning broadcast system 10 of the present invention. Furthermore, the decision unit 160 is connected to both the local earthquake detecting system 120 and the central earthquake detecting system 140, such that earthquake information may be exchanged. Therefore, accuracies of the earthquake warning signal ES1 and the earthquake warning signal ES2 may be mutually compared, so as to avoid occasions of false alarm.

In the embodiments of the present invention, the set of earthquake detectors 100 may be deployed according to a specific rule. The specific rule comprises a geographic parameter and a reference economic value, for example, a geological zone (e.g., a fault zone), an area (e.g., urban, suburban or mountain area), indoor/outdoor (including high/low floor), a population density, a unit economic value of building, a fragility of building, etc., which are not limited herein. Under a condition of the set of earthquake detectors 100 deployed near buildings with high economic value, the embodiments of the present invention may significantly reduce economic loss caused by the earthquake. Under a condition of the set of earthquake detectors 100 deployed in an area with high population density, the embodiments of the present invention may significantly reduce casualties caused by the earthquake.

In addition, performing the decision determination in the embodiment of the present invention may comprise determining whether the earthquake warning signal ES1 and the earthquake warning signal ES2 are higher than a triggering threshold TH, determining an arrival order of the earthquake warning signal ES1 and the earthquake warning signal ES2, and determining an accuracy of the earthquake warning signal ES1 and the earthquake warning signal ES2, wherein the triggering threshold TH may be configured according to user requirements. When the triggering threshold TH is configured as a low value, the earthquake warning system may urge the subscribers to escape and gain more time for escape, such that major damage is avoided. When the triggering threshold TH is configured as a high value, over-frequent alarms causing the subscribers nervous and false alarms are avoided. If the earthquake warning signal (e.g., ES1 or ES2) is lower than the triggering threshold TH, the decision unit 160 neglects the earthquake warning signal.

In order to make the earthquake warning more precisely, the decision unit 160 may perform analysis on the earthquake warning signal ES1 and the earthquake warning signal ES2, and compare the accuracies of the earthquake warning signal ES1 and the earthquake warning signal ES2 with each other. In order to make the earthquake warning timelier, the decision unit 160 bases on the arrival order of the earthquake warning signal ES1 and the earthquake warning signal ES2, and sends the earthquake warning signal which arrives first to the warning devices 180.

In short, the set of earthquake detectors 100 should be deployed in the zone Z according to the specific rule such as geological structures, fault zone information, the unit economic value of building, etc. When the set of earthquake detectors 100 detects an earthquake occurs, the local earthquake detecting system 120 generates the earthquake warning signal ES1. Meanwhile, by cooperating with the central earthquake detecting system 140, the earthquake warning signal ES2 is received. When the decision unit 160 receives the earthquake warning signal ES1 or the earthquake warning signal ES2, the decision unit 160 performs the decision determination to determine whether the earthquake warning signal ES1 or the earthquake warning signal ES2 is higher than the triggering threshold TH and neglect the earthquake warning signal lower than the triggering threshold TH. The decision unit 160 sends the earthquake warning signal which arrives first to the plurality of warning devices 180 according to the arrival order of the earthquake warning signals. When the warning devices 180 receive the earthquake warning signal (either the earthquake warning signal ES1 or the earthquake warning signal ES2), the warning devices 180 broadcast the earthquake alarm to prompt the subscribers in the zone Z. The subscribers in the zone Z may share the cost of deploying the local earthquake detecting system 120, such that more subscribers utilize the earthquake warning broadcast system 10 of the present invention and the damage caused by the earthquake is significantly reduced.

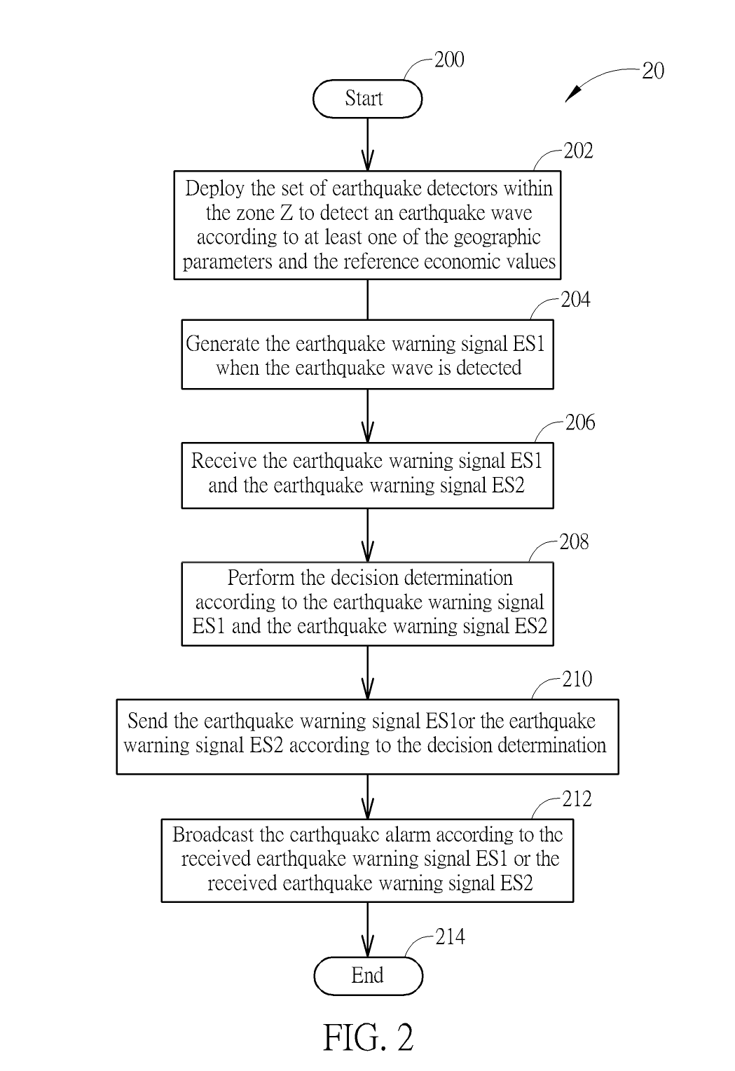

The operating method of the earthquake warning broadcast system 10 can be further summarized into a process 20, as shown in FIG. 2. The process 20 may be utilized for performing earthquake alarm and comprises the following steps.

Step 200: Start.

Step 202: Deploy the set of earthquake detectors within the zone Z to detect an earthquake wave according to at least one of the geographic parameters and the reference economic values.

Step 204: Generate the earthquake warning signal ES1 when the earthquake wave is detected.

Step 206: Receive the earthquake warning signal ES1 and the earthquake warning signal ES2.

Step 208: Perform the decision determination according to the earthquake warning signal ES1 and the earthquake warning signal ES2.

Step 210: Send the earthquake warning signal ES1 or the earthquake warning signal ES2 according to the decision determination.

Step 212: Broadcast the earthquake alarm according to the received earthquake warning signal ES1 or the received earthquake warning signal ES2.

Step 214: End.

Details of the process 20 may be referred to related paragraphs in the above, which are not narrated herein.

In summary, the earthquake warning broadcast system of the present invention may broadcast the earthquake alarm to many subscribers within the zone through the cheap warning devices. The subscribers share the cost of deploying the local earthquake detecting system. In comparison to the expensive earthquake detecting system in the prior art, the embodiments of the present invention make the earthquake warning broadcast system affordable by more subscribers. In addition, the embodiment of the present invention connects to both the local earthquake detecting system and the central earthquake detecting system, and performs exchange of earthquake information. Therefore, occasions of false alarm are reduced and accuracy of the earthquake warning is enhanced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An earthquake warning method, comprising:
deploying a set of earthquake detectors within a zone according to a specific rule to detect an earthquake wave;
generating a first earthquake warning signal when the earthquake wave is detected;
receiving the first earthquake warning signal and a second earthquake warning signal;
performing a decision determination according to the first earthquake warning signal and the second earthquake warning signal;
sending the first earthquake warning signal or the second earthquake warning signal to a plurality of warning devices according to the decision determination; and
broadcasting an earthquake alarm.

2. The earthquake warning method of claim 1, wherein the specific rule comprises at least one of a geographic parameter and a reference economic value.

3. The earthquake warning method of claim 1, wherein the step of performing the decision determination according to the first earthquake warning signal and the second earthquake warning signal comprises:
determining whether the first earthquake warning signal and the second earthquake warning signal are higher than a triggering threshold;
determining an arrival order of the first earthquake warning signal and the second earthquake warning signal; and
determining an accuracy of the first earthquake warning signal and the second earthquake warning signal.

4. The earthquake warning method of claim 3, wherein sending the first earthquake warning signal or the second earthquake warning signal to the plurality of warning devices according to the decision determination comprises sending the first earthquake warning signal or the second earthquake warning signal to the plurality of warning devices when at least one of the first earthquake warning signal and the second earthquake warning signal is higher than the triggering threshold.

5. The earthquake warning method of claim 3, wherein sending the first earthquake warning signal or the second earthquake warning signal to the plurality of warning devices according to the decision determination is sending the first earthquake warning signal or the second earthquake warning signal to the plurality of warning devices according to the arrival order.

6. The earthquake warning method of claim 3, wherein sending the first earthquake warning signal or the second earthquake warning signal to the plurality of warning devices according to the decision determination is sending the first earthquake warning signal or the second earthquake warning signal to the plurality of warning devices according to the accuracy.

7. The earthquake warning method of claim 3, further comprising configuring the triggering threshold.

8. The earthquake warning method of claim 1, wherein the zone is a range in which the earthquake wave is capable of propagating.

9. The earthquake warning method of claim 1, wherein the second earthquake warning signal is from a central earthquake detecting system.

10. An earthquake warning broadcast system, comprising:
a set of earthquake detectors, deployed within a zone according to a specific rule, for detecting an earthquake wave;
a local earthquake detecting system, coupled to the set of earthquake detectors, for generating a first earthquake warning signal when the earthquake wave is detected;
a central earthquake detecting system, for generating a second earthquake warning signal when the earthquake wave is detected;
a decision unit, coupled to the local earthquake detecting system and the central earthquake detecting system, for performing a decision determination according to the first earthquake warning signal and the second earthquake warning signal, and sending the first earthquake warning signal or the second earthquake warning signal according to the decision determination; and
a plurality of warning devices, coupled to the decision unit, for receiving the first earthquake warning signal or the second earthquake warning signal, and broadcasting an earthquake alarm.

11. The earthquake warning broadcast system of claim 10, wherein the specific rule comprises at least one of a geographic parameter and a reference economic value.

12. The earthquake warning broadcast system of claim 10, wherein the decision unit determines whether the first earthquake warning signal and the second earthquake warning signal are higher than a triggering threshold, determines an arrival order of the first earthquake warning signal and the second earthquake warning signal, and determines an accuracy of the first earthquake warning signal and the second earthquake warning signal.

13. The earthquake warning broadcast system of claim 12, wherein the decision unit sends the first earthquake warning signal or the second earthquake warning signal to the plurality of warning devices when at least one of the first earthquake warning signal and the second earthquake warning signal is higher than the triggering threshold.

14. The earthquake warning broadcast system of claim 12, wherein the decision unit sends the first earthquake warning signal or the second earthquake warning signal to the plurality of warning devices according to the arrival order.

15. The earthquake warning broadcast system of claim 12, wherein the decision unit sends the first earthquake warning signal or the second earthquake warning signal to the plurality of warning devices according to the accuracy.

16. The earthquake warning broadcast system of claim 12, wherein the decision unit is further utilized for configuring the triggering threshold.

17. The earthquake warning broadcast system of claim 10, wherein the zone is a range in which the earthquake wave is capable of propagating.
